(19) United States
(12) Patent Application Publication
(10) Pub. No.: US 2005/0135892 A1
(43) Pub. Date: Jun. 23, 2005

(54) End milling cutter assembly

(76) Inventor: An Kuo Tang, Daya Township (TW)

Correspondence Address: CHARLES E. BAXLEY, ESQ., 90 JOHN STREET, THIRD FLOOR, NEW YORK, NY, 10038, US

(21) Appl. No.: 10/740,113

(22) Filed: Dec. 17, 2003

(51) Int. Cl. B23B 31/02

(52) U.S. Cl. 409/234

(57) ABSTRACT

An end milling cutter assembly includes a handle and a cutter bar is connected to the handle by inserting an insertion into a receiving recess defined in the handle. A first bolt threadedly extends through a threaded hole defined radially in the handle and contacts a surface defined in an outer periphery of the insertion. A second bolt threadedly extends through a passage defined longitudinally in the handle and is threadedly connected to a threaded recess defined in the insertion. The total length of the assembly is shortened and the cutter bar is positioned in two different directions by the two bolts.

### FIELD OF THE INVENTION

The present invention relates to an end milling cutter assembly wherein the cutter bar is secured in two different directions and the whole length is shortened so as to avoid from shaking and bending.

### BACKGROUND OF THE INVENTION

A conventional end milling cutter assembly is shown in FIG. 1 and generally includes a handle 10 that has an sleeve 15 extending from a lower end thereof and two threaded holes 150 are defined radially through the sleeve 15. A recess 151 is defined in a distal end of the sleeve 15 so as to receive a cutter bar 20 therein. The cutter bar 20 is secured in positioned by two bolts 16 which are engaged with the threaded holes 150 and contact a surface defined in an outer periphery of the cutter bar 20 in the recess 151. The end milling cutter is fixed to the cutter bar 20 so as to mill an object. Referring to FIG. 2, because the length of the cutter bar 20 is too long, when milling the object, the cutter bar 20 shakes as shown and severely affects the result of milling. Besides, as shown in FIG. 3, when the end milling cutter is used to mill along an inclined surface of an object, the cutter bar 20 could be bent because the inclined surface applies a force to the cutter bar 20 only at one direction.

The present invention intends to provide an end milling cutter assembly which has a shorter length and the cutter bar is secured in two different directions.

### SUMMARY OF THE INVENTION

The present invention relates to an end milling cutter assembly which comprises a handle with a passage defined longitudinally therethrough and a receiving recess is defined in an end of the handle so as to receive an insertion of a cutter bar. A threaded hole is defined radially through the handle and in communication with the passage. The cutter bar has a surface defined in an outer periphery of the insertion and a first bolt is engaged with the threaded hole so as to contact the surface of the cutter bar. A second bolt is securely engaged with the passage in the handle and threadedly engaged with the threaded recess in the insertion of the cutter bar.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional end milling cutter assembly;

FIG. 2 shows that the cutter bar of the conventional end milling cutter assembly shakes during milling;

FIG. 3 shows that the cutter bar of the conventional end milling cutter assembly bends during milling;

FIG. 4 is an exploded view to show the end milling cutter assembly of the present invention;

FIG. 5 shows the insertion of the cutter bar is secured in two different directions;

FIG. 6 shows the enlarged head of the handle and the flange of the cutter bar of the present invention are matched with each other, and FIG. 7 shows a comparison between the conventional end milling cutter assembly and the end milling cutter assembly of the present invention.

### DETAILED DESCRIPTION OF THE PREFERRED EMBODIMENT

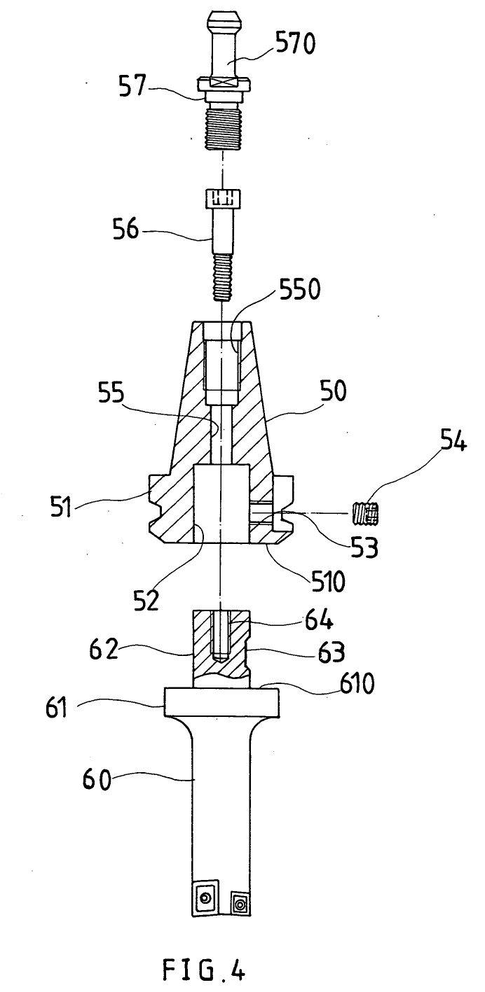

Referring to FIGS. 4 and 5, the end milling cutter assembly of the present invention comprises a handle 50 which has an enlarged head 51 at a first end thereof and an enlarged threaded recess 550 defined in a second end of the handle 50. A passage 55 is defined longitudinally in the handle 50 and shares a common axis of the enlarged threaded recess 550. A receiving recess 52 is defined in an end of the enlarged head 51 and a threaded hole 53 is defined radially through the enlarged head 51 of the handle 50. The threaded hole 53 and the receiving recess 52 are respectively in communication with the passage 55 in two different directions.

A cutter bar 60 has an insertion 62 on an end thereof and a threaded recess 64 is defined in the insertion 62. A surface 63 is defined in an outer periphery of the insertion 62. The insertion 62 is inserted in the receiving recess 52 and a first bolt 54 is engaged with the threaded hole 53 and contacts the surface 63 of the cutter bar 60 so as to secure the cutter bar 60 in horizontal direction. A second bolt 56 is securely engaged with the passage 55 in the handle 50 and threadedly engaged with the threaded recess 64 in the insertion 62 of the cutter bar 60. The cutter bar 60 is then securely positioned in the vertical direction. A third bolt 57 is threadedly engaged with the enlarged threaded recess 550 and includes a connection bar 570 so as to be connected to a milling machine which is not shown.

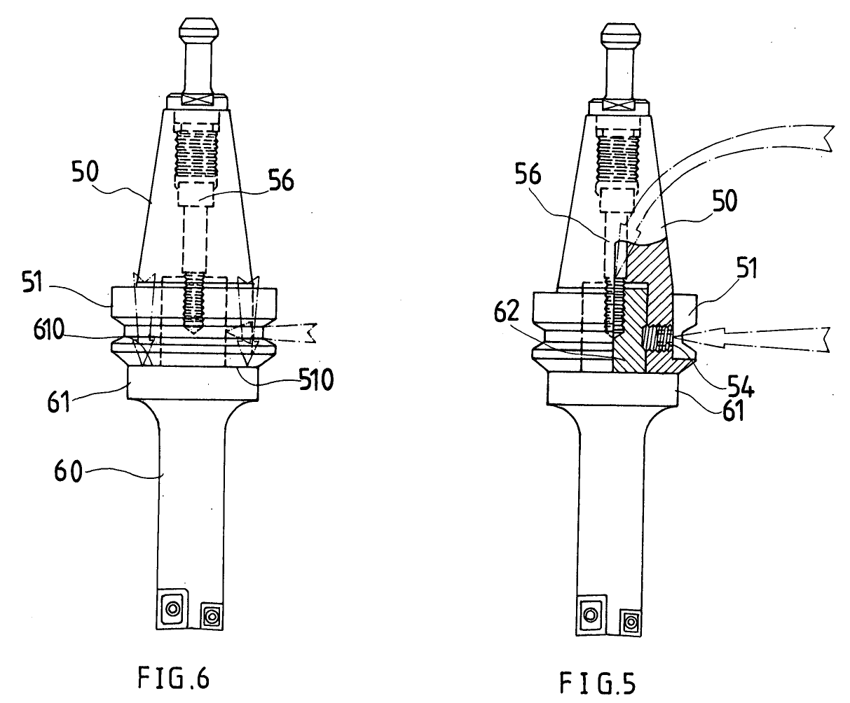

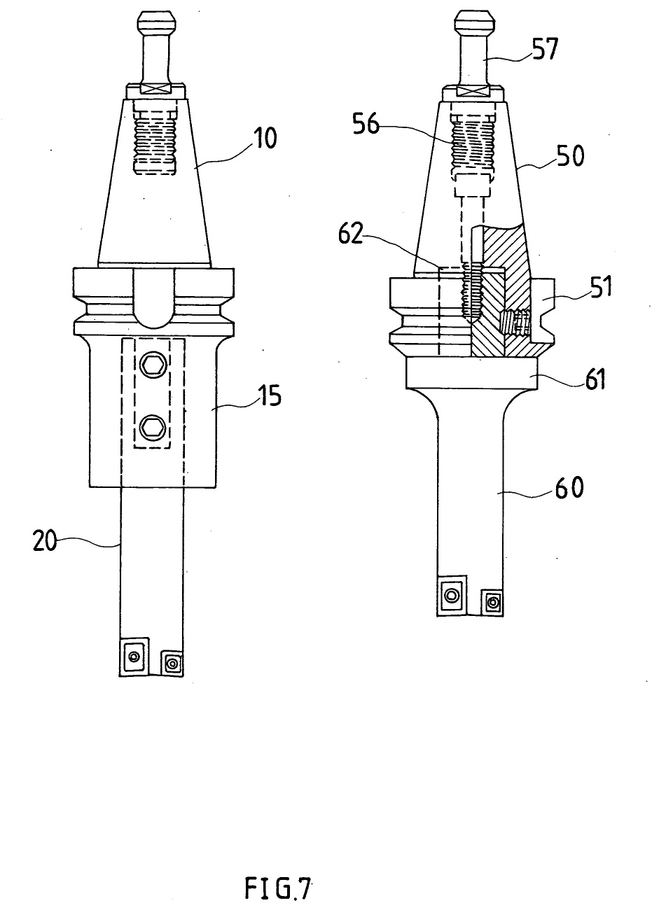

As shown in FIG. 6, the enlarged head 51 has a first flat end surface 510 and the cutter bar 60 includes a flange 61 wherein the insertion 62 is located at a center of the flange 61. The flange 61 has a second flat end surface 610 which is matched with the first flat end surface 510 when the handle 50 and the cutter bar 60 is connected to each other. By the engagement of the two flat end surfaces 510, 610, the cutter bar 60 is secured and does not shifted relative to the handle 50 during milling.

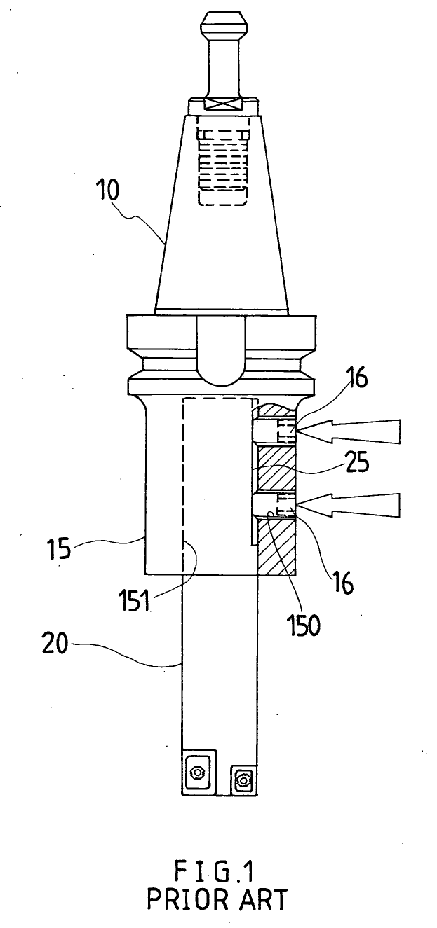

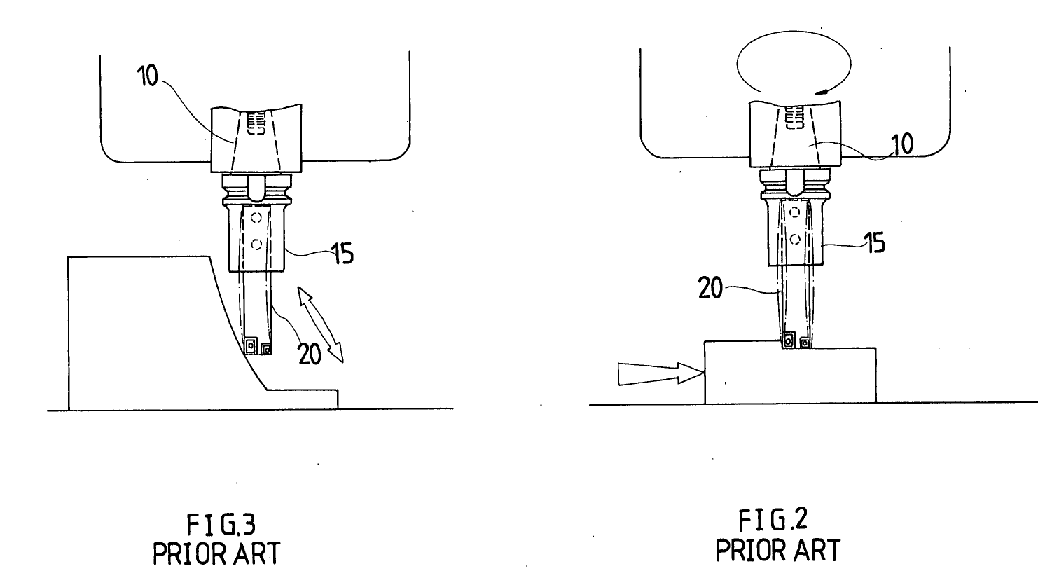

As shown in FIG. 7, because the assembly of the present invention needs no sleeve 15 as disclosed in FIG. 1, the length of the assembly of the present invention is shorter than the conventional end cutter milling assembly and this is helpful to reduce shaking during operation.

While we have shown and described the embodiment in accordance with the present invention, it should be clear to those skilled in the art that further embodiments may be made without departing from the scope of the present invention.

1. An end milling cutter assembly comprising:
a handle having a passage defined longitudinally therethrough and a receiving recess defined in an end of the handle, a threaded hole defined radially through the handle, the threaded hole and the receiving recess respectively in communication with the passage in two different directions;
a cutter bar having an insertion on an end thereof and a threaded recess defined in the insertion, a surface defined in an outer periphery of the insertion, the insertion inserted in the receiving recess and a first bolt engaged with the threaded hole and contacting the surface of the cutter bar, and
a second bolt securely engaged with the passage in the handle and being threadedly engaged with the threaded recess in the insertion of the cutter bar.

2. The assembly as claimed in claim 1, wherein the handle has an enlarged head in which the receiving recess is defined and the enlarged head includes a first flat end surface, the cutter bar including a flange and the insertion located at a center of the flange, the flange having a second flat end surface which is matched with the first flat end surface.

3. The assembly as claimed in claim 1, wherein the handle has an enlarged threaded recess which is in communication with the passage and sharing a common axis of the passage, a third bolt being threadedly engaged with the enlarged threaded recess and including a connection bar.
